(19) United States
(12) Patent Application Publication
(10) Pub. No.: US 2024/0092690 A1
(43) Pub. Date: Mar. 21, 2024

(54) RESIN COATING DEVICE

(71) Applicant: SUMITOMO ELECTRIC INDUSTRIES, LTD., Osaka-shi (JP)

(72) Inventors: Kazumasa OISHI, Osaka-shi (JP); Ken MANABE, Osaka-shi (JP); Manabu SHIOZAKI, Osaka-shi (JP); Satoshi YOSHIKAWA, Osaka-shi (JP)

(21) Appl. No.: 18/470,050

(22) Filed: Sep. 19, 2023

(30) Foreign Application Priority Data
Sep. 21, 2022 (JP) 2022-150489

(51) Int. Cl. C03C 25/18; C03C 25/24

(52) U.S. Cl. CPC C03C 25/18; C03C 25/24

(57) ABSTRACT

A resin coating device for coating a surface of a glass fiber, includes: a point having a point hole; a die disposed directly below the point and including a first alignment portion, a second alignment portion, and a first die hole; and a first resin supply path. The second alignment portion is disposed below the first alignment portion. The first alignment portion includes a first diameter-reduced portion, and a first land portion disposed, connected to the first diameter-reduced portion, and having a constant diameter in the traveling direction. The second alignment portion includes a second diameter-reduced portion, and a second land portion, connected to the second diameter-reduced portion, and having a constant diameter in the traveling direction. The first diameter-reduced portion, the first land portion, the second diameter-reduced portion, and the second land portion are each a part of the first die hole.

### TECHNICAL FIELD

The present disclosure relates to a resin coating device. This application claims priority based on Japanese Patent Application No. 2022-150489 filed on Sep. 21, 2022, and the entire contents of which are incorporated herein by reference.

### BACKGROUND ART

JPH09-086971A discloses an optical fiber resin coating device that forms a two-layer coating on a surface of a glass fiber.

### SUMMARY

A resin coating device according to the present disclosure is
a resin coating device for coating a surface of a glass fiber with a resin by allowing the glass fiber to pass therethrough, and includes:
a point having a point hole through which the glass fiber is inserted;
a die disposed directly below the point and including a first alignment portion, a second alignment portion, and a first die hole through which the glass fiber is inserted; and
a first resin supply path connected to an inlet of the first die hole, in which
the second alignment portion is disposed below the first alignment portion in a traveling direction of the glass fiber,
the first alignment portion includes a first diameter-reduced portion whose diameter is reduced downward from an inlet in the traveling direction, and a first land portion disposed directly below the first diameter-reduced portion, connected to the first diameter-reduced portion, and having a constant diameter in the traveling direction,
the second alignment portion includes a second diameter-reduced portion whose diameter is reduced downward from an inlet in the traveling direction, and a second land portion disposed directly below the second diameter-reduced portion, connected to the second diameter-reduced portion, and having a constant diameter in the traveling direction, and
the first diameter-reduced portion, the first land portion, the second diameter-reduced portion, and the second land portion are each a part of the first die hole.

### BRIEF DESCRIPTION OF DRAWING

FIG. 1s a schematic cross-sectional view of a resin coating device according to an embodiment of the present disclosure.

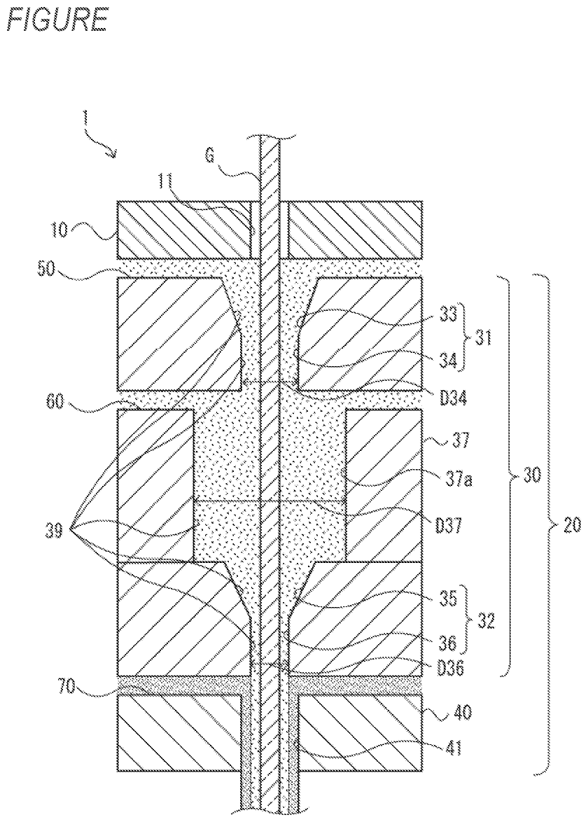

### DESCRIPTION OF EMBODIMENTS

An attempt to form a thinner coating layer may result in an uneven thickness.

An object of the present disclosure is to provide a resin coating device capable of preventing an uneven thickness when thinly coating a glass fiber with a resin.

According to the present disclosure, it is possible to provide a resin coating device capable of preventing an uneven thickness when thinly coating a glass fiber with a resin.

### Description of Embodiment of Present Disclosure

First, an embodiment of the present disclosure will be listed and described.

(1) A resin coating device according to an embodiment of the present disclosure is a resin coating device for coating a surface of a glass fiber with a resin by allowing the glass fiber to pass therethrough, and includes:
a point having a point hole through which the glass fiber is inserted;
a die disposed directly below the point and including a first alignment portion, a second alignment portion, and a first die hole through which the glass fiber is inserted; and
a first resin supply path connected to an inlet of the first die hole, in which
the second alignment portion is disposed below the first alignment portion in a traveling direction of the glass fiber,
the first alignment portion includes a first diameter-reduced portion whose diameter is reduced downward from an inlet in the traveling direction, and a first land portion disposed directly below the first diameter-reduced portion, connected to the first diameter-reduced portion, and having a constant diameter in the traveling direction,
the second alignment portion includes a second diameter-reduced portion whose diameter is reduced downward from an inlet in the traveling direction, and a second land portion disposed directly below the second diameter-reduced portion, connected to the second diameter-reduced portion, and having a constant diameter in the traveling direction, and
the first diameter-reduced portion, the first land portion, the second diameter-reduced portion, and the second land portion are each a part of the first die hole.

The die of the resin coating device according to the present disclosure incudes the first diameter-reduced portion and the second diameter-reduced portion each having a diameter reduced in the traveling direction. Since a vibration in a direction perpendicular to the traveling direction of the glass fiber is restrained at two points, i.e., the first diameter-reduced portion and the second diameter-reduced portion, the vibration of the glass fiber can be prevented. Accordingly, an uneven thickness can be prevented, and the glass fiber can be coated with the resin with higher dimensional accuracy.

(2) In the above (1),
the die may further include an intermediate portion,
the intermediate portion may have a hole that is between the first alignment portion and the second alignment portion and that is a part of the first die hole, and
a diameter of the hole in the intermediate portion may be greater than both the diameter of the first land portion and the diameter of the second land portion.

Since the diameter of the hole in the intermediate portion is greater than both the diameter of the first land portion and the diameter of the second land portion, the hole in the intermediate portion is easier to process as compared with the case where the diameter of the hole in the intermediate portion is equal to or smaller than the diameter of the first land portion and the diameter of the second land portion. Further, a length of contact between the glass fiber and the resin can be increased, and the vibration of the glass fiber can be prevented by the resin, as compared with the case where the intermediate portion is not provided.

(3) In the above (2), the resin coating device may further include a second resin supply path connected to the hole in the intermediate portion.

Since the resin coating device according to the present disclosure includes the second resin supply path connected to the hole in the intermediate portion, the resin is also supplied to the hole in the intermediate portion, and a resin pressure in the first die hole is increased. Therefore, the glass fiber can be coated with the resin while preventing air bubbles from entering the first die hole.

(4) In the above (3), the second resin supply path may be connected to an upper part of the intermediate portion.

Since the second resin supply path is connected to the upper part of the intermediate portion, the resin pressure in the first die hole can be increased, occurrence of an uneven thickness can be prevented, and a circumferential direction of the glass fiber can be uniformly coated with the resin.

(5) In any one of the above (1) to (4), the diameter of the first land portion may be greater than the diameter of the second land portion.

Since the diameter of the first land portion is greater than the diameter of the second land portion, the glass fiber is less likely to hit the point or the die at the point or the inlet of the die, and disconnection of the glass fiber can be prevented. Further, the uneven thickness can be prevented by slightly tilting the entire resin coating device in front, rear, left, and right directions with the second alignment portion as a center of rotation.

(6) In any one of the above (1) to (5),
the die may include a first die having the first die hole, and a second die disposed directly below the first die and having a second die hole, and
the resin coating device may further include another supply path configured to supply a resin different from the resin to the second die from between the first die and the second die.

Since the resin coating device according to the present disclosure includes a plurality of dies and another supply path, the glass fiber can be substantially simultaneously coated with two resins.

### Details of Embodiment of Present Disclosure

A specific example of a resin coating device 1 according to an embodiment of the present disclosure will be described with reference to the drawing.

The present disclosure is not limited to these exemplifications, but is indicated by the scope of claims, and is intended to include all modifications within a scope and meaning equivalent to the scope of claims.

FIGURE is a schematic cross-sectional view of the resin coating device 1 according to the embodiment of the present disclosure. The resin coating device 1 is configured to coat a surface of a glass fiber G with a resin by allowing the glass fiber G to pass therethrough. A diameter of the glass fiber G is, for example, φ80 μm to φ125 μm. As shown in FIGURE, the resin coating device 1 includes a point 10, a die 20, a first resin supply path 50, a second resin supply path 60, and a third resin supply path 70.

The point 10 is disposed at an inlet of the resin coating device 1. The point 10 has a point hole 11 through which the glass fiber G is inserted. A cross section of the point hole in a plane perpendicular to a traveling direction of the glass fiber G is circular. A diameter of the point hole 11 is, for example, φ0.30 mm to φ0.35 mm. A length of the point hole 11 in the traveling direction of the glass fiber G is, for example, 2.0 mm.

The die 20 includes a first die 30 and a second die 40. The first die 30 is disposed directly below the point 10 in the traveling direction of the glass fiber G. The first die 30 includes a first alignment portion 31, a second alignment portion 32, and a first die hole 39 through which the glass fiber G is inserted. Further, the first die 30 includes an intermediate portion 37 disposed between the first alignment portion 31 and the second alignment portion 32. The first alignment portion 31, the intermediate portion 37, and the second alignment portion 32 may be formed individually or integrally with one another. For example, the first alignment portion 31, the intermediate portion 37, and the second alignment portion 32 may be made of the same material and then integrally formed by crimping.

The first alignment portion 31 is disposed at an inlet of the first die 30. The first alignment portion 31 includes a first diameter-reduced portion 33 and a first land portion 34. The first diameter-reduced portion 33 has a diameter reduced downward from an inlet in the traveling direction of the glass fiber G. The first land portion 34 is disposed directly below the first diameter-reduced portion 33, is connected to the first diameter-reduced portion 33, and has a constant diameter in the traveling direction of the glass fiber G. The first diameter-reduced portion 33 and the first land portion 34 are each a part of the first die hole 39. It is preferable that a projection (not shown) projecting from an outlet of the first alignment portion 31 (an outlet of the first land portion 34) along the traveling direction of the glass fiber G is formed at the outlet of the first alignment portion 31.

Both a cross section of the first diameter-reduced portion 33 and a cross section of the first land portion 34 on the plane perpendicular to the traveling direction of the glass fiber G are circular. The diameter of the first diameter-reduced portion 33 at an inlet of the first alignment portion 31 is, for example, φ0.48 mm to φ0.53 mm. A diameter D34 of the first land portion 34 is, for example, φ0.30 mm to φ0.35 mm. A length of the first alignment portion 31 (sum of a length of the first diameter-reduced portion 33 and a length of the first land portion 34) in the traveling direction of the glass fiber G is, for example, 4.5 mm. In the present embodiment, the diameter D34 of the first land portion 34 is greater than a diameter D36 of a second land portion 36, which will be described later.

The intermediate portion 37 has a hole 37a through which the glass fiber G is inserted. The hole 37a is a part of first die hole 39. The hole 37a has a constant diameter in the traveling direction of the glass fiber G. A cross section of the hole 37a in the plane perpendicular to the traveling direction of the glass fiber G is circular. A diameter D37 of the hole 37a in the intermediate portion 37 is greater than the diameter D34 of the first land portion 34 and the diameter D36 of the second land portion 36. The diameter D37 of the hole 37a is, for example, φ8.0 mm. A length of the intermediate portion 37 in the traveling direction of the glass fiber G is, for example, 18.0 mm.

The second alignment portion 32 is disposed below the first alignment portion 31 in the traveling direction of the glass fiber G. The second alignment portion 32 in the present embodiment is disposed directly below the intermediate portion 37 and at an outlet of the first die 30. The second alignment portion 32 includes a second diameter-reduced portion 35 and the second land portion 36. The second diameter-reduced portion 35 has a diameter reduced downward from an inlet in the traveling direction of the glass fiber G. The second land portion 36 is disposed directly below the second diameter-reduced portion 35, is connected to the second diameter-reduced portion 35, and has a constant diameter in the traveling direction of the glass fiber G. The second diameter-reduced portion 35 and the second land portion 36 are each a part of the first die hole 39.

Both a cross section of the second diameter-reduced portion 35 and a cross section of the second land portion 36 on the plane perpendicular to the traveling direction of the glass fiber G are circular. The diameter of the second diameter-reduced portion 35 at an inlet of the second alignment portion 32 is, for example, φ0.28 mm to φ0.38 mm. The diameter D36 of the second land portion 36 is, for example, φ0.10 mm to φ0.20 mm. A length of the second alignment portion 32 (sum of a length of the second diameter-reduced portion 35 and a length of the second land portion 36) in the traveling direction of the glass fiber G is, for example, 4.5 mm. It is preferable that a projection (not shown) projecting from an outlet of the second alignment portion 32 (an outlet of the second land portion 36) along the traveling direction of the glass fiber G is formed at the outlet of the second alignment portion 32.

The second die 40 is disposed directly below the first die 30. The second die 40 has a second die hole 41 through which the glass fiber G is inserted. A cross section of the second die hole 41 in the plane perpendicular to the traveling direction of the glass fiber G is circular. A diameter of the second die hole 41 is, for example, φ0.20 mm to φ0.30 mm. A length of the second die hole 41 in the traveling direction of the glass fiber G is, for example, 1.0 mm.

The first resin supply path 50 is connected to an inlet of the first die hole 39. In the present embodiment, the first resin supply path 50 is connected to the inlet of the first diameter-reduced portion 33 of the first alignment portion 31. The first resin supply path 50 is configured to supply a primary resin, with which the surface of the glass fiber G is to be coated, to the first die hole 39.

The primary resin is, for example, a urethane acrylate-based UV curable resin. The primary resin is an example of a resin with which the surface of the glass fiber G is to be coated.

The second resin supply path 60 is connected to the hole 37a in the intermediate portion 37. The second resin supply path 60 is preferably connected to an upper part of the intermediate portion 37 such that the intermediate portion 37 is easily filled with the primary resin. In the present embodiment, the second resin supply path 60 is connected to an inlet of the intermediate portion 37. The second resin supply path 60 is configured to supply the primary resin to the hole 37a in the intermediate portion 37.

The third resin supply path 70 is disposed between the first die 30 and the second die 40. In the present embodiment, the third resin supply path 70 is connected to an inlet of the second die 40. The third resin supply path 70 is configured to supply a secondary resin different from the primary resin to the second die hole 41 in the second die 40. The third resin supply path 70 is an example of another supply path.

The primary resin covering the surface of the glass fiber G is coated with the secondary resin. The secondary resin is, for example, a urethane acrylate-based UV curable resin. The secondary resin is a resin whose Young's modulus after curing is higher than a Young's modulus of the primary resin after curing. The secondary resin is an example of another resin to be applied around the primary resin.

Next, how the resin coating device 1 coats the glass fiber G with the primary resin and the secondary resin will be described.

First, the glass fiber G is inserted into the point hole 11 in the point 10 disposed at the inlet of the resin coating device 1. The glass fiber G that has inserted through the point hole 11 is inserted into the first die 30.

The glass fiber G that has inserted from the point 10 passes through the first die hole 39 in the first die 30. Specifically, the glass fiber G passes through the first diameter-reduced portion 33 and the first land portion 34 of the first alignment portion 31, the intermediate portion 37, and the second diameter-reduced portion 35 and the second land portion 36 of the second alignment portion 32. At this time, the primary resin is supplied from the first resin supply path 50 and the second resin supply path 60 into the first die hole 39 in the first die 30 to perform filling with the primary resin. By inserting the glass fiber G into the first die hole 39 filled with the primary resin, the surface of the glass fiber G is coated with the primary resin.

First, the glass fiber G is inserted into the first diameter-reduced portion 33 of the first alignment portion 31 of the first die 30. Since the diameter of the first diameter-reduced portion 33 is gradually reduced along the traveling direction of the glass fiber G, a resin flow of the primary resin from the inlet to the outlet has a high alignment force in the first diameter-reduced portion 33. Since the glass fiber G passes through the first diameter-reduced portion 33, a vibration of the glass fiber G in a direction perpendicular to the traveling direction is prevented. Thereafter, the glass fiber G is inserted into the first land portion 34.

Since the diameter D34 of the first land portion 34 is relatively small within the first die hole 39, the vibration of the glass fiber G inserted through the first land portion 34 is prevented, and contact between the glass fiber G and the point hole 11 or the first die hole 39 can be prevented. The glass fiber G that has inserted through the first land portion 34 is inserted into the intermediate portion 37.

The hole 37a in the intermediate portion 37 is filled with the primary resin through the second resin supply path 60. The glass fiber G is inserted into the hole 37a filled with the primary resin. Thereafter, the glass fiber G is inserted into the second alignment portion 32.

Since the diameter of the second diameter-reduced portion 35 of the second alignment portion 32 is gradually reduced along the traveling direction of the glass fiber G, a resin flow of the primary resin from the inlet to the outlet has a high alignment force in the second diameter-reduced portion 35. Since the glass fiber G passes through not only the first diameter-reduced portion 33 but also the second diameter-reduced portion 35, the glass fiber G is restrained at two points, i.e., the first diameter-reduced portion 33 and the second diameter-reduced portion 35, and the vibration of the glass fiber G in the direction perpendicular to the traveling direction is further prevented. Thereafter, the glass fiber G is inserted into the second land portion 36 from the second diameter-reduced portion 35.

The diameter of the second land portion 36 is the smallest within the first die hole 39. When the glass fiber G passes through the second land portion 36, the vibration is prevented and a diameter of the glass fiber G coated with the primary resin is determined. Thereafter, the glass fiber G is inserted into the second die 40.

The glass fiber G coated with the primary resin by the first die 30 passes through the second die hole 41 in the second die 40. At this time, the secondary resin is supplied from the third resin supply path 70 and the second die hole 41 is filled with the secondary resin. By inserting the glass fiber G into the second die hole 41 filled with the secondary resin, the primary resin on the glass fiber G is coated with the secondary resin. In this manner, the resin coating device 1 coats the glass fiber G with the primary resin and the secondary resin.

As described above, since the first die 30 of the resin coating device 1 includes the first diameter-reduced portion 33 and the second diameter-reduced portion 35, the glass fiber G is restrained at two points, i.e., the first diameter-reduced portion 33 and the second diameter-reduced portion 35. Since the vibration of the glass fiber G in the direction perpendicular to the traveling direction is further prevented, the circumferential direction of the glass fiber G can be coated with the primary resin more uniformly and with higher dimensional accuracy, and the uneven thickness can be prevented.

When the first die 30 of the resin coating device 1 according to the present embodiment includes the intermediate portion 37, a length of contact between the glass fiber G and the primary resin is increased. For example, when the first die 30 includes the intermediate portion 37, the length of contact between the glass fiber G and the primary resin is about 30 mm, while a length of the first die 30 without the intermediate portion 37 is about 10 mm. In this manner, when the length of contact between the glass fiber G and the primary resin is increased, the vibration of the glass fiber G can be prevented by the primary resin as compared with the case where the intermediate portion 37 is not provided.

In addition, the diameter D37 of the hole 37a in the intermediate portion 37 is greater than the diameter D34 of the first land portion 34 and the diameter D36 of the second land portion 36. Therefore, the hole 37a can be easier to process and the production cost can be reduced, as compared with the case where the diameter D37 of the hole 37a is equal to or smaller than the diameter D34 and the diameter D36.

The resin coating device 1 according to the present embodiment includes the second resin supply path 60 connected to the hole 37a in the intermediate portion 37. Since the primary resin is supplied from the first resin supply path 50 to the first alignment portion 31, and the primary resin is also supplied from the second resin supply path 60 to the hole 37a in the intermediate portion 37, the resin pressure of the primary resin in the first die hole 39 is increased. Therefore, the glass fiber G can be coated with the primary resin while preventing air bubbles from entering the first die hole and preventing the vibration of the glass fiber G.

The second resin supply path 60 according to the present embodiment is connected to the upper part of the intermediate portion 37. Therefore, the hole 37a is easily filled with the primary resin, as compared with the case where the second resin supply path 60 is connected to another position in the intermediate portion 37. The vibration of the glass fiber G is also prevented by the resin pressure of the primary resin in the intermediate portion 37. Therefore, it is possible to prevent the occurrence of the uneven thickness while preventing air bubbles from flowing into the first die hole 39.

In the present embodiment, the diameter D34 of the first land portion 34 is greater than the diameter D36 of the second land portion 36. Therefore, disconnection of the glass fiber G due to the contact between the glass fiber G and the point hole 11 or the first die hole 39 can be prevented. Further, when finely adjusting the amount of the primary resin applied, the entire resin coating device 1 can be slightly tilted in front, rear, left, and right directions with the second alignment portion 32 as a center of rotation. Such fine adjustment can further prevent the uneven thickness.

Since the resin coating device 1 according to the present embodiment includes the second die 40 and the third resin supply path 70, the glass fibers G can also be coated with the secondary resin different from the primary resin. Therefore, the glass fiber G can be substantially simultaneously coated with two resins by one device.

Although the present disclosure has been described in detail and with reference to the specific embodiments, it will be apparent to those skilled in the art that various changes and modifications can be made without departing from the spirit and scope of the present disclosure. In addition, the number, positions, shapes, and the like of the constituent members described above are not limited to those in the above embodiment, and can be changed to suitable numbers, positions, shapes, and the like in carrying out the present disclosure.

For example, although the first die 30 according to the present embodiment includes the intermediate portion 37, the intermediate portion 37 may not be provided. Even in such a case, since the glass fiber G is restrained at two points, i.e., the first diameter-reduced portion 33 and the second diameter-reduced portion 35, the vibration of the glass fiber G is prevented, and the uneven thickness can be prevented. Further, the configuration of the first die 30 is simplified, and the production cost can be reduced.

Although the resin coating device 1 according to the present embodiment includes the second resin supply path 60, the second resin supply path 60 may not be provided. Even in such a case, since the glass fiber G is restrained at two points, i.e., the first diameter-reduced portion 33 and the second diameter-reduced portion 35, the glass fiber G is less likely to vibrate, and the uneven thickness can be prevented. In addition, when the intermediate portion 37 is not provided in the first die 30, the glass fibers G can be coated with the primary resin by supplying the primary resin from the first resin supply path 50.

The second resin supply path 60 may be connected to an intermediate part or a lower part of the intermediate portion 37. Accordingly, as compared with the case where the second resin supply path 60 is not provided, the glass fibers G can be coated with the primary resin by filling the hole 37a in the intermediate portion 37 with the primary resin.

The resin coating device 1 may not include the second die 40 and the third resin supply path 70. In a case of coating the glass fiber G with only one type of resin, it is not necessary to provide these configurations.

1. A resin coating device for coating a surface of a glass fiber with a resin by allowing the glass fiber to pass therethrough, the resin coating device comprising:
a point having a point hole through which the glass fiber is inserted;
a die disposed directly below the point and including a first alignment portion, a second alignment portion, and a first die hole through which the glass fiber is inserted; and
a first resin supply path connected to an inlet of the first die hole, wherein
the second alignment portion is disposed below the first alignment portion in a traveling direction of the glass fiber,
the first alignment portion includes a first diameter-reduced portion whose diameter is reduced downward from an inlet in the traveling direction, and a first land portion disposed directly below the first diameter-reduced portion, connected to the first diameter-reduced portion, and having a constant diameter in the traveling direction,
the second alignment portion includes a second diameter-reduced portion whose diameter is reduced downward from an inlet in the traveling direction, and a second land portion disposed directly below the second diameter-reduced portion, connected to the second diameter-reduced portion, and having a constant diameter in the traveling direction, and
the first diameter-reduced portion, the first land portion, the second diameter-reduced portion, and the second land portion are each a part of the first die hole.

2. The resin coating device according to claim 1, wherein
the die further includes an intermediate portion,
the intermediate portion has a hole that is between the first alignment portion and the second alignment portion and that is a part of the first die hole, and
a diameter of the hole in the intermediate portion is greater than both the diameter of the first land portion and the diameter of the second land portion.

3. The resin coating device according to claim 2, further comprising:
a second resin supply path connected to the hole in the intermediate portion.

4. The resin coating device according to claim 3, wherein
the second resin supply path is connected to an upper part of the intermediate portion.

5. The resin coating device according to claim 1, wherein
the diameter of the first land portion is greater than the diameter of the second land portion.

6. The resin coating device according to claim 1, wherein
the die includes a first die having the first die hole, and a second die disposed directly below the first die and having a second die hole, and
the resin coating device further includes another supply path configured to supply a resin different from the resin to the second die from between the first die and the second die.
